(19) United States
(12) Patent Application Publication
(10) Pub. No.: US 2019/0082371 A1
(43) Pub. Date: Mar. 14, 2019

(54) SYSTEMS AND METHODS FOR HANDOVER OF A SET OF WIRELESS DEVICES

(71) Applicant: QUALCOMM Incorporated, San Diego, CA (US)

(72) Inventors: Stephen Burt, Cambridge (GB); Mauro Scagnol, Great Cambourne (GB); Nicolas Graube, Cambridge (GB); Ian Blair, Cambridge (GB)

(21) Appl. No.: 15/699,119

(22) Filed: Sep. 8, 2017

(51) Int. Cl. H04W 36/36; H04W 36/30; H04W 36/08; H04W 8/00

(52) U.S. Cl. CPC H04W 36/36; H04W 36/30; H04W 84/20; H04W 8/005; H04W 36/08

(57) ABSTRACT

A method for handover of a set of wireless devices is described. The method includes receiving, at a first wireless device of the set of wireless devices, data from a first serving device of a set of serving devices. The first wireless device has a primary wireless device role and a second wireless device has a non-primary wireless device role. The method includes determining, at the first wireless device, a handover condition for the set of wireless devices. The set of wireless devices is handed over as a set to a second serving device. The method includes becoming detectable, by the first wireless device. Each of the wireless devices in the set of wireless devices is configured to become detectable in response to the handover condition. The method includes receiving, by the first wireless device, an indication of a selected wireless device of the set of wireless devices.

### TECHNICAL FIELD

The present disclosure relates generally to wireless communications. More specifically, the present disclosure relates to systems and methods for handover of a set of wireless devices.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Many electronic devices may make use of wireless communication technology. For example, a wireless communication device may communicate with one or more remote devices using wireless technology.

In some cases, wireless communications may offer limited flexibility and/or quality. For example, some wireless communications may be degraded. As can be observed from this discussion, improvements in wireless communication may be beneficial.

### SUMMARY

A method for handover of a set of wireless devices is described. The method includes receiving, at a first wireless device of the set of wireless devices, data from a first serving device of a set of serving devices. The first wireless device has a primary wireless device role and a second wireless device has a non-primary wireless device role. The method also includes determining, at the first wireless device, a handover condition for the set of wireless devices. The set of wireless devices is handed over as a set to a second serving device. The method further includes becoming detectable, by the first wireless device. Each of the wireless devices in the set of wireless devices is configured to become detectable in response to the handover condition. The method additionally includes receiving, by the first wireless device, an indication of a selected wireless device of the set of wireless devices. Becoming detectable may include beaconing.

The selected wireless device may be a designated primary wireless device that takes the primary wireless device role upon handover. The selected wireless device may be the second wireless device that takes the primary wireless device role upon handover. The first wireless device may become a designated non-primary wireless device that takes the non-primary wireless device role upon handover. Receiving the indication of the selected wireless device may include receiving, by the first wireless device from the second wireless device, an indicator that the second wireless device is the designated primary wireless device.

The method may include receiving second data by the first wireless device. The second data may be relayed by the second wireless device to the first wireless device from the second serving device of the set of serving devices. The set of serving devices may form a connected graph topology.

Determining the handover condition may include determining that the primary wireless device has lost connection with the set of serving devices. Determining the handover condition may include receiving an indication from the first serving device that a measured signal quality is below a threshold.

The set of wireless devices may be a set of wireless audio output devices. The set of wireless devices may be a set of Bluetooth devices and the set of serving devices may be a set of Bluetooth serving devices. The set of wireless devices may include two or more non-primary wireless devices that have the non-primary device role.

A first wireless device for handover of a set of wireless devices is also described. The first wireless device includes a memory and a processor coupled to the memory. The processor is configured to receive, at the first wireless device, data from a first serving device of a set of serving devices. The first wireless device has a primary wireless device role and a second wireless device has a non-primary wireless device role. The processor is also configured to determine a handover condition for the set of wireless devices. The set of wireless devices is handed over as a set to a second serving device. The processor is further configured to become detectable. Each of the wireless devices in the set of wireless devices is configured to become detectable in response to the handover condition. The processor is additionally configured to receive an indication of a selected wireless device of the set of wireless devices.

A non-transitory tangible computer-readable medium for handover of a set of wireless devices is also described. The computer-readable medium includes code for causing a first wireless device to receive, at the first wireless device of the set of wireless devices, data from a first serving device of a set of serving devices. The first wireless device has a primary wireless device role and a second wireless device has a non-primary wireless device role. The computer-readable medium also includes code for causing the first wireless device to determine a handover condition for the set of wireless devices. The set of wireless devices is handed over as a set to a second serving device. The computer-readable medium further includes code for causing the first wireless device to become detectable. Each of the wireless devices in the set of wireless devices is configured to become detectable in response to the handover condition. The computer-readable medium additionally includes code for causing the first wireless device to receive an indication of a selected wireless device of the set of wireless devices.

A method for handover by a set of serving devices is also described. The method includes sending first data from one of the set of serving devices to a first wireless device that has a primary wireless device role. The method also includes receiving, at one or more of the set of serving devices, a signal from at least one of a set of wireless devices. Each of the set of wireless devices is configured to become detectable in response to a handover condition. The method further includes cooperatively determining, by all of the set of serving devices in response to the received signal, a selected wireless device of the set of wireless devices and a selected serving device of the set of serving devices. The method additionally includes sending an indication of the selected wireless device from the selected serving device to the selected wireless device. The selected wireless device may take the primary wireless device role upon handover. The set of serving devices may form a connected graph topology.

The method may include determining the handover condition by determining that a measured signal quality for the first wireless device is below a threshold. The method may also include sending, from the one of the set of serving devices to the first wireless device, an indication that the measured signal quality is below the threshold.

Cooperatively determining the selected wireless device and the selected serving device may include determining a signal quality measurement for two or more pairs. Each pair may include a wireless device and a serving device. Cooperatively determining the selected wireless device and the selected serving device may include determining a wireless device and serving device pair based on the signal quality measurement and a wireless device role for each of the set of wireless devices. The determination may favor a second wireless device that has a non-primary wireless device role over the first wireless device that has the primary wireless device role.

### BRIEF DESCRIPTION OF THE DRAWINGS

FIG. 1 is a block diagram illustrating one configuration of a wireless communication system in which systems and methods for handover of a set of wireless devices may be implemented;

FIG. 2 is a flow diagram illustrating a method for handover of a set of wireless devices within a set of serving devices;

FIG. 3 is a flow diagram illustrating another method for handover of a set of wireless devices within a set of serving devices;

FIG. 4 is a block diagram illustrating one example of a scenario for streaming audio;

FIG. 5 is a block diagram illustrating a roaming scenario;

FIG. 6 is a block diagram illustrating a handover scenario;

FIG. 7 is a thread diagram illustrating an example of wireless device set handover in accordance with some configurations of the systems and methods disclosed herein;

FIG. 8 is a flow diagram illustrating a more specific method for handover of a set of wireless devices within a set of serving devices; and

FIG. 9 illustrates certain components that may be included within a wireless communication device.

### DETAILED DESCRIPTION

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Some configurations of the systems and methods disclosed herein may relate to handover of a set of wireless devices. For example, some implementations of the systems and methods disclosed herein may relate to two or more wireless devices (e.g., independent wireless devices in a set of wireless devices) cooperating during a handover.

A reference scenario is given as follows. An example of a wireless system (e.g., an entirely wireless system) involving three or more interacting devices can be found in a pair of wireless earbuds (e.g., an earbud set). One of the wireless earbuds (e.g., the “primary” earbud) may be connected over Bluetooth to a smartphone that is providing a constant or sporadic data flow to the bud (e.g., an audio stream). The whole or a part of the data may then be transparently relayed by the primary earbud to the other earbud (e.g., the “secondary” or “non-primary” earbud) via another bud-to-bud background wireless connection, using the same or another wireless technology (e.g., Near Field Magnetic Induction (NFMI)). The secondary earbud may also extract data directly from the flow transmitted to the primary, without any direct interaction with the data source, while the overall operation of the two buds may be transparently managed by them using the background bud-to-bud wireless connection. This may allow the bud-to-bud wireless connection to be entirely transparent to the smartphone and it does not require updates of the mainstream operating system (e.g., connectivity stack) in order to interoperate with the earbud set (as compared to a system where each bud would have to be managed by the smartphone). The same consideration may apply not only to mobiles, but also to other service providers that are supporting wireless and standardized interoperation profiles such as, for example, laptops or Bluetooth enabled embedded platforms.

The wireless technology used to connect the earbud set to the service provider (likely in the 2.4 gigahertz (GHz) band or above, for example) will be affected by range and propagation limitations. Furthermore, since the buds are worn in the ear canal, there may be severe limitations to the physical size and placement of the antenna in the bud and, depending on the attitude and the physical posture of the user, their own body might impair line of sight propagation from the device connected to the primary bud and strongly attenuate the intensity of the signal received as the user moves in their environment.

To address the issue above and/or to free the users from the need of carefully positioning the service provider and/or of carrying it with them while moving in the environment, a network of service providers (which may be referred to as “pods” in some configurations), may be distributed inside a building. For example, two (e.g., a pair of) short range wireless (e.g., Bluetooth) earbuds may roam inside a building from one pod (e.g., wireless voice and/or audio service provider) to another. There may be a need to seamlessly hand over service to the earbuds from one pod to the other.

Once the presence of the earbud set is detected in the building (through detection of beaconing from the buds, for example), the pod network may collaboratively establish which of the pods is the better suited to connect to the set. For example, selection of the pod connection may be based on an estimation (e.g., a measurement) of an element that is most likely to result in the best possible communication. In some approaches, a comparison may be made, across the full set of pods, of signal quality measurements (e.g., received signal strength indicator (RSSI) measurements of the beacons). A chosen pod may thus connect to one of the buds (for example the one whose beacons are received with the highest signal quality (e.g., RSSI). The connected bud may become the primary earbud in the earbud set and the pod may become the earbuds' service provider (e.g., the serving pod).

As the users freely interact with their environment and/or roam from room to room in the building, propagation of signals between the earbud set and the serving pod is affected. For example, the earbuds may be distinct wireless devices with very different signal propagation characteristics (considering a user's body interposition and/or spatial diversity, for instance). A new pod in the network could thus become more suitable to be the serving pod. A service handover may be orchestrated by the pod network and connectivity to the earbuds may be handed over (e.g., seamlessly handed over) from the old serving pod to the new one that the earbud set is roaming to. For example, an earbud may accept a new connection, drop an existing connection, and/or may initiate a connectable state through advertising. Additionally, or alternatively, both earbuds may cooperate in the management of the handover from pod to pod (one earbud may form a connection with a new pod before the connection to the old one is broken, for instance).

Handing over connectivity from one pod to another may include making and breaking of wireless connections between the two pods and the earbud set. For a seamless service handover, without the risk of data buffer under-run for example, the roamed-to pod (e.g., the “new” pod) may establish a reliable connection with the earbud set before connectivity with the previous serving pod is dropped. This may provide for no apparent interruption in the data being streamed or collected from the set. Accordingly, if the connection being established by the new pod is to the same bud connected to the old serving pod (e.g., the primary bud in the set), at least on a temporary basis, the number of channels addressing the primary earbud may be higher than normal. In the long term, this may cause a battery usage asymmetry between primary and secondary buds. Furthermore, if the primary bud is the only one in the set that can be targeted for an handover procedure, given that the user is constantly changing their posture and multipath interference, the user's body may adversely affect signal propagation between the bud and both the serving and the roamed-to pods, thus making connectivity quality widely vary before, during and after the handover.

One or more of the aforementioned issues may be addressed in accordance with some configurations of the systems and methods disclosed herein. Some handover techniques of the connectivity to one device from one service provider to another are known. For example, a 2G phone on a voice call may be handed-over between two cells. In some configurations of the systems and methods disclosed herein, the handover target may be actually a set of (e.g., a pair of two) distinct wireless devices, where each of the set may have very different instantaneous signal propagation characteristics. For example, the signal propagation characteristics may be very different due to the user's body interposition. Instead of using the concept of encapsulating the nature of the earbud set behind a primary earbud (which may be useful to avoid modifications to the smartphone firmware) in order to facilitate the handover, some configurations of the systems and methods disclosed herein may explicitly take advantage of the spatial separation of the multiple devices and of the available radio resource duplication.

In some configurations, multiple wireless devices (e.g., both earbuds) may cooperate in the management of the handover from serving device to serving device (e.g., from pod to pod). When the quality of the connection from the serving device to the primary wireless device starts deteriorating, multiple or all wireless devices (e.g., N wireless devices, such as 2 earbuds, etc.) may be configured to become detectable (e.g., discoverable) to the serving device(s). For example, two or more (e.g., all) of the wireless devices may start to beacon when the quality of the connection from the primary wireless device (e.g., primary bud) to the serving device (e.g., pod) falls below a certain threshold. In some approaches, the primary wireless device may notify this event to one or more other wireless devices (e.g., N−1 non-primary wireless devices, one or more secondary wireless devices, etc.) in the set on the wireless device set management connection (e.g., bud-to-bud management connection).

Given that a non-primary wireless device's (e.g., secondary wireless device's, secondary bud's, etc.) radio may be less busy than the primary wireless device's by definition (e.g., the non-primary wireless device may not be connected to the serving device), the battery may be accordingly less drained. Additionally, or alternatively, a non-primary wireless device (e.g., secondary bud) may be in a better physical position with respect to the new serving device (e.g., pod) than the primary wireless device. For example, a non-primary wireless device may be in line of sight of the new serving device (e.g., pod), located in the opposite corner of the same room where the serving pod and the user are.

In attempting a new connection, the new serving device (e.g., pod) may give preference to a non-primary wireless device (e.g., secondary bud). For example, to cope with sudden drops of the already deteriorating connectivity to the serving device, once a connection from the new serving device to non-primary wireless device is established, a duplicate of the stream of data already exchanged by the serving device (e.g., pod) and the primary wireless device (e.g., primary bud) may be exchanged over the new connection. The non-primary wireless device may signal the ongoing handover to the primary wireless device, may forward to the primary the possibly duplicate data and, if need be, the non-primary wireless device may coordinate any realignment of timing to the new serving device. When the handover is completed, the former non-primary wireless device (e.g., secondary bud), now the one actually connected to the new serving device (e.g., pod), may finally complete the handover process, becoming the new primary wireless device (e.g., bud) in the set.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

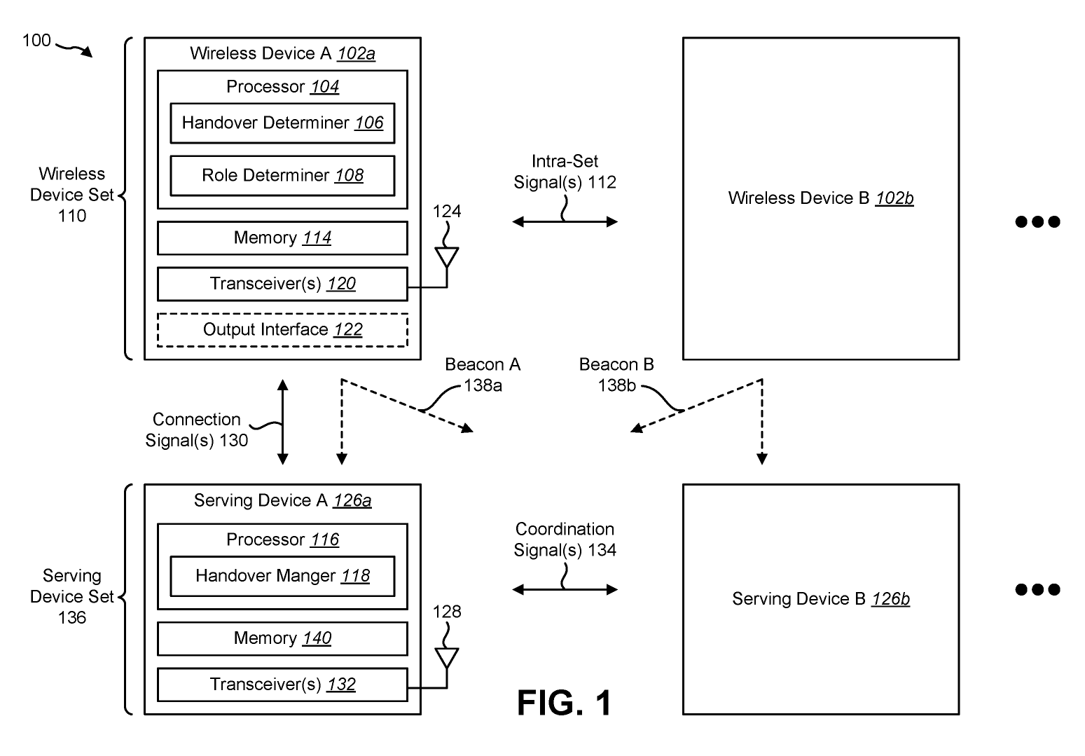

FIG. 1 is a block diagram illustrating one configuration of a wireless communication system 100 in which systems and methods for handover of a set of wireless devices may be implemented. Wireless communication systems 100 may be deployed to provide various types of communication content such as audio, video, voice, data, and so on. A wireless communication system 100 may include a wireless device set 110 and a serving device set 136. The wireless device set 110 may be a set of two or more wireless devices (e.g., wireless device A 102a, wireless device B 102b, etc.). For example, the wireless device set 110 may include a primary wireless device and one or more non-primary wireless devices. It should be noted that a generic item number for a wireless device 102 may refer to one, any, some, or all of the wireless devices 102a-b in the wireless device set 110. The serving device set 136 may be a set of two or more serving devices (e.g., serving device A 126a, serving device B 126b, etc.). It should be noted that a generic item number for a serving device 126 may refer to one, any, some, or all of the serving devices 126a-b in the serving device set 136.

In some configurations, the wireless device set 110 and the serving device set 136 may form and/or may be a part or all of a wireless personal area network (WPAN). For example, one or more of the wireless devices 102a-b and/or one or more of the serving devices 126a-b may utilize one or more WPAN communication technologies. Examples of WPAN communication technologies may include Bluetooth (BT), Institute of Electrical and Electronics Engineers (IEEE) 802.15.4, ZigBee, Wireless Universal Serial Bus (USB), Z-Wave, etc. One or more of the wireless devices 102a-b and/or serving devices 126a-b may implement one or more WPAN communication technologies in some configurations. In some implementations, one or more other wireless communication technologies (e.g., wireless wide area network (WWAN) technologies, cellular technologies, Long Term Evolution (LTE), third-generation (3G cellular, wireless local area network (WLAN) technologies, Institute of Electrical and Electronics Engineers (IEEE) 802.11 (Wi-Fi) technologies, NFMI technologies, etc.) may be implemented in one or more of the wireless devices 102a-b and/or the serving devices 126a-b in addition to or alternatively from the one or more WPAN communication technologies. For example, the wireless device set 110 and the serving device set 136 may form and/or may be a part or all of a WLAN, a WWAN, and/or another network. In some implementations, multiple wireless communication technologies may share one or more antennas 124.

Examples of wireless devices 102a-b include wireless audio output devices (e.g., wireless ear buds, wireless headsets, wireless speakers, etc.), cellular phones, smartphones, tablet devices, laptop computers, wireless modems, e-readers, gaming systems, vehicles (e.g., automobile electronics, automobile consoles, etc.), drones, aircraft, robots, medical equipment, remotely operated devices (e.g., vehicles, robots, drones, toys, etc.), appliances, cameras, sensors, etc. In a specific example, the wireless device set 110 may be a set of sensors may be worn by a person, where the set of sensors may wirelessly communicate. The set of sensors (instead of a single sensor for example) may be used to better estimate one or more metrics (e.g., health, fitness, and/or performance, etc.). Some of these devices may operate in accordance with one or more industry standards. More specific examples of the wireless devices 102a-b (e.g., wireless device set 110) may include BT earbuds, a BT headset, and BT speakers.

Examples of serving devices 126a-b include serving network devices (e.g., wireless audio serving base stations, pods, audio pods, etc.), base stations, access points, cellular phones, smartphones, tablet devices, laptop computers, desktop computers, routers, wireless modems, e-readers, gaming systems, vehicles (e.g., automobile electronics, automobile consoles, etc.), drones, aircraft, robots, medical equipment, appliances, cameras, etc. Some of these devices may operate in accordance with one or more industry standards. Some implementations of the systems and methods disclosed herein may include a set of wireless earbuds roaming between audio serving devices (in a WPAN, for example).

In some configurations, each of the wireless devices 102 in the wireless device set 110 may be of the same type or similar type of device. For example, wireless device A 102a may be a wireless left earbud and wireless device B 102b may be a wireless right earbud. In another example, each of the wireless devices 102 in the wireless device set 110 may be wireless speakers. In some configurations, two or more of the wireless devices 102 in the wireless device set 110 may be of different types. For example, wireless device A 102a may be a tablet device and wireless device B 102b may be a portable projector.

Some communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. Improved performance (e.g., higher throughput, increased range, greater capacity, and/or improved reliability) may be achieved if the additional dimensionalities created by the multiple transmit and/or receive antennas are utilized.

One or more of the wireless devices 102a-b may communicate with one or more of the serving devices 126a-b. Each of the one or more wireless devices 102a-b may include one or more antennas 124. Each of the serving devices 126a-b may include one or more antennas 128 for communicating wirelessly with one or more of the wireless devices 102a-b (e.g., for transmitting and/or receiving connection signals 130). As used herein, the term “communicate” and variations thereof may include transmitting and/or receiving signals between devices. For example, “communicating” may include “being in a connection with” or “broadcasting to” (e.g., sending a broadcast beacon to). For instance, wireless device A 102a may transmit one or more connection signals 130 to and/or may receive one or more connection signals 130 from serving device A 126a. Examples of the connection signals 130 may include packets (e.g., connection setup packets, connection packets, payload data, audio packets, video packets, etc.), data, audio (e.g., music, voice calls, etc.), speech, video, etc. The communication between wireless device A 102a and serving device A 126a may be bi-directional. For example, wireless device A 102a and serving device A 126a may transmit signals to and receive signals from each other.

The wireless device set 110 may be handed over (e.g., roam, move, etc.) as a set. For instance, if any of the two or more wireless devices 102a-b is handed over, all of the other wireless devices 102a-b will be handed over (e.g., the wireless device set 110 may be coherent with respect to its relation with the serving device set 136). In one example, the wireless device set 110 may roam between serving devices 126a-b (e.g., within the serving device set 136). In another example, one or more of the wireless devices 102 in the wireless device set 110 may be stationary (while another wireless device 102 is moving, for instance) and the wireless device set 110 may be handed over together. In yet another example, all wireless devices 102 in the wireless device set 110 may be stationary, but environmental conditions (e.g., slow fading, blockages, etc.) may change, causing the wireless device set 110 to be handed over. In some configurations, each of the wireless devices 120a-b may be independent in that each wireless device 102a-b may be independently capable of connecting directly to a serving device 126a-b.

In some configurations of the systems and methods disclosed herein, the relationship between each serving device 126a-b and each wireless device 102a-b may change. Additionally, or alternatively, the role of each wireless device 102a-b may change. For instance, wireless device A 102a may have a primary wireless device role for a period of time and then wireless device B 102b may take the primary wireless device role, where the wireless device with the primary wireless device role manages the connection signal(s) 130 with the serving device set 136. In some configurations, the relationship between each serving device 126a-b and each wireless device 102a-b may not be static. This contrasts with a static relationship, for example, where the roles of a primary wireless device and a non-primary wireless device may not change. In a static relationship, for instance, a non-primary wireless device may only communicate indirectly with (e.g., receive signals from) a serving device via the primary device and that relationship may not change.

As used herein, the term “primary wireless device” may refer to a wireless device that has a primary wireless device role and the term “non-primary wireless device” may refer to a wireless device that has a non-primary or secondary wireless device role. In some configurations, a primary wireless device may communicate with (e.g., maintain a connection and/or link with) at least one serving device. For example, the primary wireless device may relay information between one or more serving devices and/or one or more non-primary wireless devices. Additionally or alternatively, a non-primary wireless device may communicate with the primary wireless device (directly and/or via one or more non-primary wireless devices) and/or may communicate with at least one serving device via the primary wireless device. In some configurations, any non-primary wireless device may be a secondary wireless device. For example, any wireless device in a wireless device set that is not the primary wireless device (e.g., does not have the primary wireless device role) may be a secondary wireless device. It should be noted that wireless device roles may change (e.g., a primary wireless device may become a non-primary wireless device and vice versa). Similar terminology may be used with respect to serving devices and/or serving device roles. In some configurations, for example, a primary serving device may communicate with (e.g., maintain a connection and/or link with) the primary wireless device.

It should be noted that the primary role may be with respect to a function provided to or by a primary servicing device in some configurations. This may be since it is possible that both primary elements (e.g., primary wireless device and primary serving device) have a common connection shared. In some configurations, the role(s) may be determined, selected, dictated, designated, and/or indicated by one or more serving devices 126. For example, the serving device set 136 may select a wireless device 102 to take the primary wireless device role.

One or more of the wireless devices 102a-b may become detectable (e.g., detectable to one or more serving devices 126a-b ). For example, each wireless device 102a-b may send a respective beacon 138a-b (or other signal). Each beacon 138a-b may be a signal that indicates the presence of a corresponding wireless device 102a-b and/or a request for a connection. In some configurations, each beacon 138a-b may indicate the wireless device set 110 to which each corresponding wireless device 102a-b belongs. In some approaches, becoming detectable may include becoming responsive to one or more signals from the serving device(s) 126a-b. For example, if a serving device 126 sends a discovery request (e.g., inquiry) signal, any wireless device 102 receiving the discovery request signal may send a response signal (e.g., a beacon 138 or other response signal).

Wireless devices 102a-b may communicate with each other using intra-set signal(s) 112. For example, the wireless devices 102a-b may communicate within the wireless device set 110 using wireless signaling. The intra-set signal(s) 112 may be similar in type to the connection signal(s) 130 or may be different in type from the connection signal(s) 130. In some configurations, for example, the intra-set signal(s) 112 may be Bluetooth Basic Rate/Enhanced Data Rat (BR/EDR) signals and the connection signal(s) 130 may be Bluetooth BR/EDR. In other configurations, the intra-set signal(s) 112 may be NFMI signals and the connection signal(s) may be Bluetooth BR/EDR. In yet another example, the intra-set signal(s) 112 may be Bluetooth signals and the connection signal(s) may be Wi-Fi signals. Other combinations may be implemented.

In some configurations, communication within the wireless device set 110 may be via at least one wireless link. For example, the wireless device set 110 may be wire-free and/or may not be coupled together with a wire. In some configurations, the wireless device set 110 may be a set of wireless earphones (e.g., earbuds) or a set of wireless speakers.

The intra-set signal(s) 112 may include control signaling and/or payload signaling. In some approaches, a primary wireless device 102 may relay data to one or more non-primary wireless devices 102. For example, the inter-set signal(s) 112 may include signaling to relay information (e.g., audio, video, data, etc.). For instance, wireless device A 102a may relay a channel of audio (e.g., right channel audio) to wireless device B 102b. For instance, wireless device A 102a may receive dual channel audio as a connection signal 130 from serving device A 126a. Wireless device A 102a may then relay an audio signal (e.g., the dual channel signal or one channel of the dual channel signal) to wireless device B 102b. Additionally, or alternatively, the intra-set signal(s) 112 may include signaling to indicate a handoff condition, a command to send beacons 138a-b, a selected wireless device (e.g., a wireless device selected to be a primary wireless device), a wireless device role indication (e.g., primary wireless device, non-primary wireless device, etc.), synchronization signaling, etc.

The serving devices 126a-b may communicate with each other using coordination signal(s) 134. For example, the serving devices 126a-b may communicate within the serving device set 136 using wired and/or wireless signaling. For example, two or more serving devices 126a-b may be linked via a wired connection (e.g., Ethernet, Universal Serial Bus, power-line communication, broadband over power line (BPL), etc.). Additionally, or alternatively, two or more serving devices 126a-b may be linked via a wireless connection (e.g., Bluetooth, Wi-Fi, cellular, etc.). The coordination signal(s) 134 may be similar in type to the connection signal(s) 130 or may be different in type from the connection signal(s) 130.

The coordination signal(s) 134 may include control signaling and/or payload signaling. For example, the coordination signal(s) 134 may include signaling to relay payload information (e.g., audio, video, data, etc.) and/or an index of payload information (e.g., packet number, amount of payload information sent, frame number, stream time, current play time, etc.). Additionally, or alternatively, the coordination signal(s) 134 may include signaling to indicate beacon 138a-b reception, signal quality measurements (e.g., RSSI measurements), handoff coordination signaling, serving device selection indication (e.g., a serving device selected to be a primary serving device), a serving device role indication (e.g., primary serving device, non-primary or secondary serving device, etc.), etc.

In some configurations, the wireless communication system 100 may include a connected graph topology. For example, the serving device set 136 may form (e.g., may be arranged in) a connected graph topology. In a connected graph topology, there may be a path (e.g., connection) from any node (e.g., device) to any other node (e.g., device) in the graph. For instance, at least one serving device 126a-b in the serving device set 136 may be capable of communicating with at least one other serving device 126a-b. In some configurations, at least one serving device 126a-b may be capable of communicating with at least one wireless device 102a-b in the wireless device set 110. While not in handover procedures, for example, only one of the wireless devices 102a-b may be connected to a serving device 126a-b in some approaches. During handover procedures, multiple wireless devices 102a-b may be connected to one or more serving devices 126a-b in some approaches.

In some examples, wireless device A 102a may be a primary wireless device and all other wireless devices 102 may be non-primary (e.g., secondary) wireless devices. There may be a connection path (e.g., a connection path may exist) from at least one non-primary wireless device to the primary wireless device. Each wireless device 102 may be connected to at least one other wireless device in the wireless device set 110. In some configurations, the wireless device set 110 may additionally or alternatively form a connected graph. For example, wireless devices in a wireless device set may be pairwise connected eventually forming a connected graph. In some configurations, each device (e.g., wireless device and serving device) may have a connection path (directly or via one or more devices, for example) to all other devices in the connected graph. In some approaches, any member of the wireless device set 110 may take the primary wireless device role (e.g., may become the primary wireless device).

In some configurations, wireless device A 102a may include a processor 104, a memory 114, one or more transceivers 120, and/or an output interface 122. The processor 104 may be coupled to (e.g., in electronic communication with) the memory 114, the transceiver(s) 120, and/or the output interface 122. The processor 104 may include and/or implement a handover determiner 106 and/or a role determiner 108. It should be noted that one or more of the elements illustrated in FIG. 1 may be optional. In particular, the wireless device 102 may not include one or more of the elements illustrated in FIG. 1 in some configurations. For example, wireless device A 102a may or may not include an output interface 122. One or more other wireless devices 102 (e.g., wireless device B 102b) may include similar components and/or elements as wireless device A 102a. For example, each wireless device 102 in the wireless device set 110 may include a processor, memory, transceiver(s), and/or an output interface. Additionally, or alternatively, each processor of each wireless device 102 may include and/or implement a handover determiner and/or a role determiner. The components and/or elements of each wireless device 102 may operate the same or similarly as described herein with respect to wireless device A 102a.

The memory 114 may store instructions and/or data. The processor 104 may access (e.g., read from and/or write to) the memory 114. Examples of instructions and/or data that may be stored by the memory 114 may include received data (e.g., data from a connection signal 130), handover determiner 106 instructions, role determiner 108 instructions, and/or instructions for other elements, etc. In some configurations, the wireless device 102 (e.g., the memory 114) may include a data buffer (not shown). The data buffer may buffer (e.g., store) received data (from the transceiver(s) 120, for example).

The transceiver(s) 120 may enable wireless device A 102a to receive signals (e.g., connection signal(s) 130 and/or intra-set signal(s) 112) from and/or to transmit signals (e.g., connection signal(s) 130, intra-set signal(s) 112, and/or beacon A 138a) to one or more devices (e.g., other wireless devices 102b, one or more serving devices 126a-b , etc.). For example, the transceiver(s) 120 may provide an interface for wireless communications. The transceiver(s) 120 may be coupled to one or more antennas 124 for transmitting and/or receiving radio frequency (RF) signals.

The output interface 122 may be an interface for providing one or more kinds of output (e.g., audio, visual, and/or tactile output) to a user. In some configurations, the output interface 122 may include one or more speakers for outputting audio (e.g., music, speech, sound, etc.). Additionally, or alternatively, the output interface 122 may include one or more displays for presenting visual content (e.g., photo, video, etc.). Additionally, or alternatively, the output interface 122 may include one or more devices (e.g., vibration motors) for providing tactile output. It should be noted that some configurations may not include an output interface 122.

In some configurations, wireless device A 102a may include a battery. The battery may provide electrical power for the functioning of wireless device A 102a. The battery may be rechargeable and/or replaceable in some implementations.

The handover determiner 106 may determine a handover condition for the wireless device set 110. For example, when a handover condition occurs, the handover determiner 106 may determine that all wireless devices 102a-b in the wireless device set 110 will be handed over between serving devices 126a-b (e.g., from serving device A 126a to serving device B 126b). Examples of handover conditions may include a connection loss at the primary wireless device (e.g., wireless device A 102a) and/or receiving an indication from a serving device 126 (that a measured signal quality is below a threshold, for example).

The handover determiner 106 may determine (e.g., detect) one or more handover conditions. In some approaches, the handover determiner 106 may determine that the primary wireless device (e.g., wireless device A 102a) has lost connection with the serving device set 136 (e.g., with serving device A 126a). For example, the handover determiner 106 may determine that one or more connection signals 130 are not being received (e.g., received correctly). Additionally, or alternatively, the handover determiner 106 may determine that one or more signals (e.g., connection signal(s) 130) transmitted from wireless device A 102a are not being acknowledged (e.g., no acknowledgement signal is being received). Quality of communication may indicate a state of a connection. For example, the handover determiner 106 may determine that a connection communication quality is degraded as a handover condition.

In some approaches, the handover determiner 106 may additionally or alternatively determine a handover condition by receiving an indication from a serving device (e.g., serving device A 126a). The indication may indicate an initiation of handover procedures. In some configurations, the indication may indicate connection deterioration (e.g., that a measured signal quality (e.g., RSSI) is below a threshold). For example, serving device A 126a may measure signal quality based on signals received from wireless device A 102a. If the signal quality falls below a threshold, serving device A 126a may send an indication to wireless device A 102a that the connection is deteriorated (e.g., that measured signal quality is below a threshold). The handover determiner 106 may utilize the received indication to determine the handover condition.

In response to a handover condition (e.g., if the handover determiner 106 has determined and/or detected a handover condition), all of the wireless devices 102 in the wireless device set 110 may become detectable (e.g., may transmit beacons 138, may transmit a signal, and/or may become responsive to a discovery request (e.g., inquiry) signal from one or more serving devices 126, etc.). For example, wireless device A 102a may transmit beacon A 138a and wireless device B 102b may transmit beacon B 138b. In some approaches, a wireless device 102 (e.g., wireless device A 102a and/or wireless device B 102b) may send and/or receiving intra-set signals 112 indicating that a handover condition has been determined. In response to the indication, each receiving wireless device 102 may send a beacon 138. The beacons 138 may be received by one or more of the serving devices 126 in the serving device set 136.

In some configurations, serving device A 126a may include a processor 116, a memory 140, and/or one or more transceivers 132. The processor 116 may be coupled to (e.g., in electronic communication with) the memory 140 and/or the transceiver(s) 132. The processor 116 may include and/or implement a handover manager 118. Serving device A 126a may or may not include an output interface. One or more other serving devices 126 (e.g., serving device B 126b) may include similar components and/or elements as serving device A 126a. For example, each serving device 126 in the serving device set 136 may include a processor, memory, transceiver(s), and/or an output interface. Additionally, or alternatively, each processor of each serving device 126 may include and/or implement a selector. The components and/or elements of each serving device 126 may operate the same or similarly as described herein with respect to serving device A 126a.

The memory 140 may store instructions and/or data. The processor 116 may access (e.g., read from and/or write to) the memory 140. Examples of instructions and/or data that may be stored by the memory 140 may include received data (e.g., data from a connection signal 130), handover manager 118 instructions, and/or instructions for other elements, etc. In some configurations, the serving device 126 (e.g., the memory 140) may include a data buffer (not shown). The data buffer may buffer (e.g., store) received data (from the transceiver(s) 132, for example).

The transceiver(s) 132 may enable serving device A 126a to receive signals (e.g., connection signal(s) 130, beacons 138, and/or coordination signal(s) 134) from and/or to transmit signals (e.g., connection signal(s) 130 and/or coordination signal(s) 134) to one or more devices (e.g., one or more wireless devices 102, other serving devices 126b, etc.). For example, the transceiver(s) 132 may provide an interface for wireless communications. The transceiver(s) 132 may be coupled to one or more antennas 128 for transmitting and/or receiving radio frequency (RF) signals.

In some configurations, one or more serving devices 126 may include an output interface for providing one or more kinds of output (e.g., audio, visual, and/or tactile output) to a user. For example, the output interface may include one or more speakers, one or more displays, and/or one or more tactile output devices.

In some configurations, the handover manager 118 may determine a handover condition. The handover manager 118 may determine a handover condition for the wireless device set 110. For example, when a handover condition occurs, the handover manager 118 may determine that all wireless devices 102a-b in the wireless device set 110 will be handed over between serving devices 126a-b (e.g., from serving device A 126a to serving device B 126b. Examples of handover conditions may include a connection loss at the primary serving device (e.g., serving device A 126a), determining connection deterioration (e.g., that a measured signal quality is below a threshold), and/or determining a better potential connection (e.g., that a measured signal quality for another wireless device is higher than the signal quality for the primary wireless device).

The handover manager 118 may determine (e.g., detect) one or more handover conditions. In some approaches, the handover manager 118 may determine that the primary wireless device (e.g., wireless device A 102a) has lost connection with the serving device set 136 (e.g., with serving device A 126a). For example, the handover manager 118 may determine that one or more connection signals 130 are not being received (e.g., received correctly). Additionally, or alternatively, the handover manager 118 may determine that one or more signals (e.g., connection signal(s) 130) transmitted from serving device A 126a are not being acknowledged (e.g., no acknowledgement signal is being received). If the handover manager 118 determines that the connection is lost, the handover manager 118 may determine to initiate handover procedures. For example, serving device A 126a may send an indication to one or more wireless devices (e.g., wireless device A 102a) indicating handover initiation. The handover initiation indication may indicate connection loss. Additionally, or alternatively, serving device A 126a may send a coordination signal 134 to one or more other serving devices 126 indicating handover initiation. The one or more other serving devices 126 may additionally or alternatively send an indication to one or more wireless devices 102.

In some approaches, the handover manager 118 may additionally or alternatively determine connection deterioration. For example, the handover manager 118 may measure signal quality (e.g., RSSI) based on the connection signal(s) 130 and/or beacon A 138a received from wireless device A 102a. If the signal quality is below a threshold, the handover manager 118 may determine to initiate handover procedures. For example, serving device A 126a may send an indication to one or more wireless devices (e.g., wireless device A 102a) indicating handover initiation. The handover initiation indication may indicate connection deterioration (e.g., that a measured signal quality (e.g., RSSI) is below a threshold). In response to receiving the indication (e.g., handover initiation indication), the wireless devices 102 (e.g., all wireless devices 102 in the wireless device set 110) may send beacons 138.

As described herein, one or more serving devices 126 may initiate handover in some configurations. For example, one or more serving devices 126 may determine connection loss and/or connection deterioration and may send an indication to one or more wireless devices 102 initiating handover. Two or more (e.g., all) wireless devices 102 may become detectable (e.g., send beacons 138) in response to the handover initiation. Additionally, or alternatively, one or more wireless devices 102 may initiate handover in some configurations. For example, one or more wireless devices 102 may detect a connection loss and may initiate handover. All wireless devices 102 may send beacons 138 in response to the handover initiation. In some approaches, only a serving device 126 may initiate handover. In other approaches, only a wireless device 102 may initiate handover. In yet other approaches, serving devices 126 or wireless devices 102 or both may initiate handover.

One or more serving devices 126 may determine a selected wireless device 102 of the wireless device set 110. Additionally, or alternatively, the handover manager 118 may determine a selected serving device of the serving device set 136. For example, all of the serving device set 136 may cooperatively determine a selected wireless device 102 from the wireless device set 110 and/or a selected serving device 126 in response to the beaconing. In some approaches, the handover manager 118 may cooperate with one or more other serving devices 126 (e.g., one or more other handover managers of one or more other serving devices) to determine a selected wireless device 102 of the wireless device set 110. For example, the serving device set 136 may determine a signal quality measurement for each wireless device 102 with each serving device 126 (e.g., for each wireless device and serving device pair if possible). For instance, each serving device 126 (e.g., handover manager) may measure signal quality corresponding to each wireless device 102 based on received beacons.

In some approaches, one or more of the serving devices 126 may cooperate by sharing (e.g., sending) the signal quality measurements to one or more other serving devices 126. For example, serving device A 126a (e.g., handover manager 118) may send the signal quality measurements (as measured at serving device A 126a) to all other serving devices 126 (e.g., serving device B 126b). Similarly, serving device B 126b may send the signal quality measurements (as measured at serving device B 126b) to all other serving devices 126 (e.g., serving device A 126a). Each of the serving devices 126 may compare the signal quality measurements to determine the highest signal quality measurement. The wireless device 102 corresponding to the highest signal quality measurement may be selected (e.g., selected as the primary wireless device after handover). Additionally, or alternatively, the serving device 126 corresponding to the highest signal quality measurement may be selected (e.g., selected as the primary serving device after handover). For example, the serving device set 136 may cooperatively determine the selected wireless device 102 and the selected serving device 126 by determining a wireless device and serving device pair based on the signal quality measurement. It should be noted that, in some cases, one or more serving devices 126 may be unable to receive and/or measure signals (e.g., beacons) from one or more wireless devices 102. In these cases, the serving device 126 may report the absence of a signal quality measure and/or may not send a report corresponding to those wireless devices 102. In some configurations, the absent signal quality measure may not be considered in the comparison and/or may be set to an arbitrary value (e.g., 0) for comparison.

In some approaches, if a serving device 126 determines that the highest signal quality measurement corresponds to that serving device 126, the serving device 126 may designate itself as the primary serving device and may designate the wireless device 102 corresponding to the highest signal quality measurement as the primary wireless device 102. All other serving devices 126 may default to or self-designate as non-primary (e.g., secondary) serving devices 126. The serving device 126 (e.g., new primary serving device 126) may send an indication to the selected wireless device 102 (e.g., new primary wireless device 102) designating the selected wireless device 102 as the primary wireless device 102. In some configurations, the selected wireless device 102 may send an indication of the selected wireless device to one or more other wireless devices 102 (e.g., all other wireless devices 102).

In some approaches, one or more of the serving devices 126 may cooperate by sharing (e.g., sending) the signal quality measurements to one serving device 126. For example, serving device A 126a (e.g., handover manager 118) may obtain the signal quality measurements (as measured at serving device A 126a). All other serving devices 126 (e.g., serving device B 126b) may send the signal quality measurements (as measured at the respective serving device 126) to serving device A 126a. Serving device A 126a (e.g., the handover manager 118) may compare the signal quality measurements to determine the highest signal quality measurement.

The wireless device 102 corresponding to the highest signal quality measurement may be selected (e.g., selected as the primary wireless device after handover). Additionally, or alternatively, the serving device 126 corresponding to the highest signal quality measurement may be selected (e.g., selected as the primary serving device after handover). For example, the serving device set 136 may cooperatively determine the selected wireless device 102 and the selected serving device 126 by collecting all signal quality measurements at one serving device 126 (e.g., a current primary serving device, or another serving device, for instance), which may determine a selected wireless device and serving device pair based on the signal quality measurements. The serving device 126 that collects (e.g., receives and/or measures) signal quality measurements and that makes the selection may send a role indication to one or more other serving devices 126 (as a coordination signal 134, for example). The role indication may indicate whether a serving device 126 is the selected serving device (e.g., primary serving device) or not, and/or may indicate which wireless device 102 is the selected wireless device. Upon being selected, the selected serving device 126 may send an indication to the selected wireless device 102 (e.g., new primary wireless device 102) designating the selected wireless device 102 as the primary wireless device 102. In some configurations, the selected wireless device 102 may send an indication (e.g., forward (or relay) the same indication received from the selected serving device 126 or a different indication) of the selected wireless device to one or more other wireless devices 102.

In some approaches, a wireless device 102 and/or a serving device 126 may be selected based on a current role. For example, a current primary wireless device 102 may be disfavored from becoming and/or a current non-primary (e.g., secondary) wireless device 102 may be favored to become the primary wireless device 102 upon handover. In some approaches, the comparison of signal quality measurements may take into account a disfavor factor and/or a favor factor. For example, the signal quality measurements of the current primary wireless device 102 may be penalized (e.g., reduced by a disfavoring amount) before comparison. Additionally, or alternatively, the signal quality measurements of the current non-primary (e.g., secondary) wireless device(s) 102 may be aided (e.g., increased by a favoring amount) before comparison. Accordingly, a current non-primary wireless device 102 (e.g., wireless device B 102b) may be more likely to be selected than the current primary wireless device 102 (e.g., wireless device A 102a). Favoring one or more non-primary wireless devices 102 may help to balance signaling and power consumption across the wireless device set 110. It should be noted that one or more signal quality measures may be utilized for measurement and/or comparison. For example, signal strength (e.g., RSSI), signal-to-noise ratio (SNR), bit error rate (BER), and/or packet loss ratio, etc., may be utilized in accordance with some configurations of the systems and methods disclosed herein. In some configurations, BER may be used while in a connection.

One or more of the wireless devices 102 may receive an indication of a selected wireless device from at least one of the serving devices 126. For example, the selected wireless device 102 (e.g., next primary wireless device) may receive the indication from the selected serving device 126 (e.g., next primary serving device).

The processor 104 on wireless device A 102a may include and/or implement a role determiner 108. As described herein, each wireless device 102 may similarly include a role determiner 108. The role determiner 108 may determine a role for one or more wireless devices 102. For example, assume that wireless device A 102a is a non-primary wireless device. The role determiner 108 may receive an indication that wireless device A 102a is the selected wireless device. In response to the received indication, the role determiner 108 may determine that wireless device A 102a is a designated primary wireless device (e.g., will become the primary wireless device upon handover). For instance, if a non-primary wireless device is a designated primary wireless device, the non-primary wireless device will become (e.g., will adopt the role of) a primary wireless device upon handover. It should be noted that it may be possible, in some approaches, for a primary wireless device to be selected and therefore to be a designated primary wireless device, thereby becoming (e.g., remaining as) the primary wireless device after handover.

In some approaches, the selected wireless device 102 may send a role indication to one or more other wireless devices 102. For example, the role determiner 108 may send a role indication to one or more other wireless devices 102 indicating that wireless device A 102a will become the primary wireless device and/or that one or more other wireless devices will become non-primary wireless devices. For instance, the role indication may indicate a designation. The designation may be a role to be adopted upon handover. For example, if a designation indicates that a primary wireless device is a designated non-primary wireless device, the primary wireless device will become (e.g., will adopt the role of) a non-primary (e.g., secondary) wireless device upon handover. The role indication may be sent as an intra-set signal 112.

It should be noted that one or more of the elements or components of the wireless device 102 may be combined and/or divided. For example, one or more of the handover determiner 106 and/or the role determiner 108 may be combined. Additionally, or alternatively, one or more of the handover determiner 106, the role determiner 108, and/or the handover manager 118 may be divided into elements or components that perform a subset of the operations thereof.

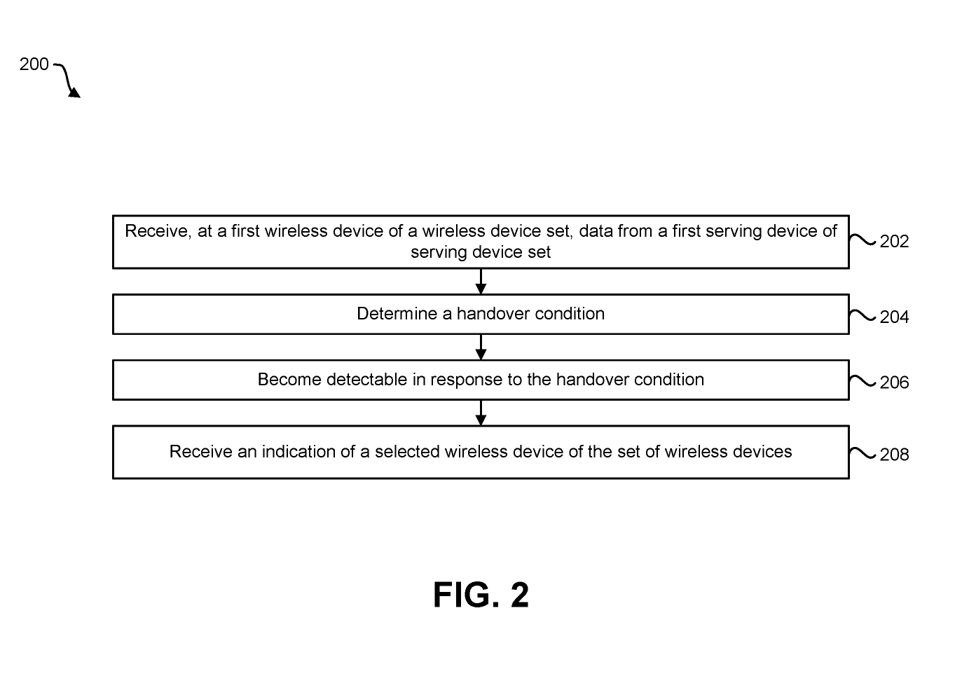

FIG. 2 is a flow diagram illustrating a method 200 for handover of a set of wireless devices within a set of serving devices. The method 200 may be performed by one or more of the wireless devices 102 (e.g., the wireless device set 110) described in connection with FIG. 1. A first wireless device 102 of a wireless device set 110 may receive 202 data from a first serving device 126 of a serving device set 136. This may be accomplished as described in connection with FIG. 1. For example, the first wireless device may have a primary wireless device role and the first serving device may have a primary serving device role (e.g., may be a primary serving device). In some configurations, the serving device set 136 may form a connected graph topology (e.g., may be arranged or connected in a connected graph topology).

In some configurations and/or cases, the first wireless device 102 may relay at least a portion of the data from the first wireless device 102 to another wireless device (e.g., a non-primary or secondary wireless device). This may be accomplished as described in connection with FIG. 1. For example, the first wireless device 102 may send a portion of the data to another wireless device via one or more inter-set signals 112. It should be noted that in some configurations and/or cases, the data may not be relayed to another wireless device. For example, all of the data may be consumed by the first wireless device 102.

The wireless device set 110 (e.g., the first wireless device 102) may determine 204 a handover condition. This may be accomplished as described in connection with FIG. 1. For example, the first wireless device 102 may receive an indication from a serving device and/or may determine a connection loss with the serving device. The indication may indicate initiation of handover procedures and/or connection deterioration (e.g., that a measured signal quality is less than a threshold). In some configurations, the wireless device (e.g., the first wireless device 102) that determines 204 the handover condition may send an indication of the handover condition to one or more other wireless device 102 (e.g., all wireless devices 102).

One or more of the wireless device set 110 (e.g., the first wireless device 102) may become detectable 206 in response to the handover condition. This may be accomplished as described in connection with FIG. 1. For instance, each of the wireless devices 102 in the wireless device set 110 may be configured to become detectable in response to the handover condition. For example, all of the wireless devices 102 in the wireless device set 110 may be configured to send signals (e.g., beacons 138, detectability signals, etc.). Additionally or alternatively, all of the wireless devices 102 in the wireless device set 110 may be configured to respond (e.g., send a response signal) to a signal (e.g., discovery request signal, inquiry signal, etc.) from one or more serving devices 126. In some approaches, the wireless device 102 that determines the handover condition may send an indication to become detectable (e.g., start beaconing) to one or more other wireless devices 102. Each wireless device 102 receiving the indication may become detectable (e.g., start beaconing).

In some approaches, although all of the wireless devices 102 in the wireless device set 110 may be configured to become detectable in response to the handover condition, not all of the wireless devices 102 may actually become detectable in some cases. For example, it may not be physically possible for all of the wireless devices 102 to become detectable because one or more of the wireless devices 102 may not have a possible communication link in some cases. For instance, all wireless devices 102 that are notified of the handover condition may become detectable in some cases.

One or more of the wireless devices 102 may receive 208 an indication of a selected wireless device of the wireless device set 110. This may be accomplished as described in connection with FIG. 1. In some configurations, the indication of the selected wireless device may be received 208 from at least one of the serving devices 126. For example, a selected serving device 126 (e.g., designated primary serving device) may send an indication of a selected wireless device to the selected wireless device 102. Additionally or alternatively, one or more of the wireless devices may receive 208 an indication of the selected wireless device from another wireless device 102. For example, the selected wireless device 102 may send an indication of the selected wireless device (e.g., role designation) to one or more other wireless devices 102. The indication may assign a role to one or more of the other wireless devices 102. In some configurations, the indication may implicitly indicate the selected serving device 126 (e.g., the serving device 126 that will take the primary serving device role). Additionally or alternatively, the indication may explicitly indicate the selected serving device 126 (e.g., data identifying the selected serving device 126).

In some approaches, the selected wireless device 102 may be a designated primary wireless device and each other wireless device 102 in the wireless device set 110 may be a designated non-primary (e.g., secondary) wireless device. Handover may occur, where the designated primary wireless device establishes a connection with a designated primary serving device. Once the (new) connection is established, the previously established connection may be discontinued (e.g., severed, stopped, etc.). Upon handover, the designated primary wireless device becomes the primary wireless device. The primary wireless device may receive data from the primary serving device and/or may relay at least a portion of the data to one or more non-primary wireless devices.

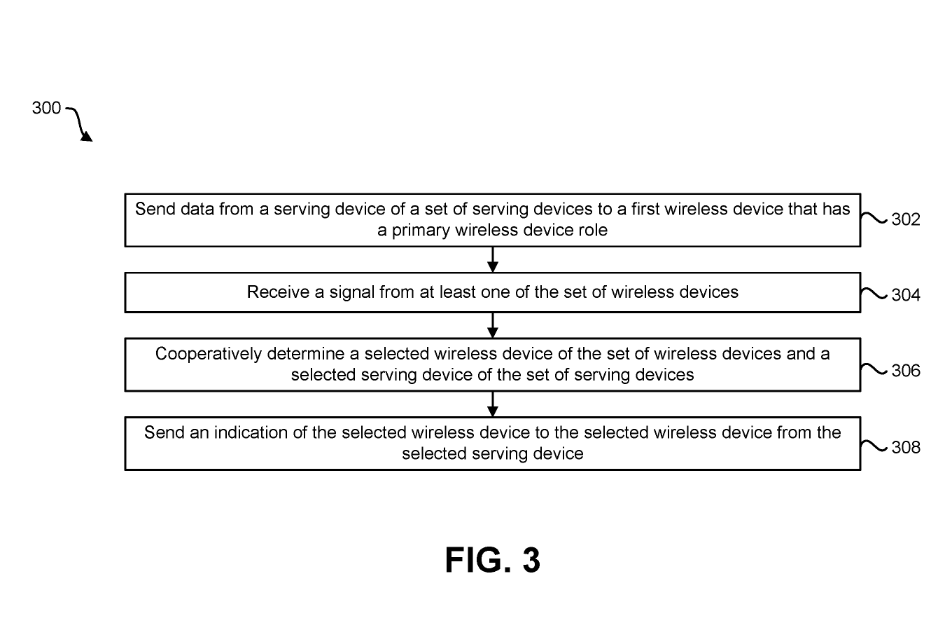

FIG. 3 is a flow diagram illustrating another method 300 for handover of a set of wireless devices within a set of serving devices. The method 300 may be performed by one or more of the serving devices 126 (e.g., the serving device set 136) described in connection with FIG. 1. A serving device 136 in the serving device set 136 (with a primary serving device role, for example) may send 302 data to a first wireless device 102 that has a primary wireless device role. This may be accomplished as described in connection with FIG. 1. For example, a connection may be established between a serving device 126 (e.g., a primary serving device) and a wireless device 102 (e.g., a primary wireless device). The serving device 126 may send 302 data via one or more connection signals 130 to the first wireless device 102.

In some configurations, one or more serving devices 126 (e.g., the primary serving device) may determine a handover condition and/or send an indication of handover procedure initiation and/or of connection deterioration. For example, a serving device 126 (e.g., primary serving device) may determine that a measured signal quality for a primary wireless device is below a threshold. The serving device 126 may send an indication to the primary wireless device that the measured signal quality is below the threshold. In some configurations, one or more wireless devices 102 may determine (e.g., detect) a handover condition. In some approaches, one or more serving devices 126a-b (e.g., the serving device set 136) may send a signal (e.g., a discovery request signal, inquiry signal, etc.) to one or more of the wireless devices 102a-b in response to determining the handover condition. In other approaches, the one or more serving devices 126a-b (e.g., the serving device set 136) may attempt to receive beaconing from the one or more of the wireless devices 102a-b in response to sending the indication of the handover procedure initiation.

The serving device set 136 may receive 304 a signal from at least one of the wireless device set 110. This may be accomplished as described in connection with FIG. 1. For example, each of the wireless devices 102 in the wireless device set 110 may be configured to become detectable (e.g., send beacons 138, send a signal in response to a discovery request or inquiry signal sent by the one or more serving devices 126, etc.) in response to the handover condition. The signal (e.g., beacons 138, response to discovery request, etc.) may be received by one or more of the serving device set 136 (e.g., all of the serving devices 126). It should be noted that the serving device set 136 may form a connected graph topology in some configurations.

The serving device set 136 may cooperatively determine 306 a selected wireless device of the wireless device set 110 and/or may cooperatively determine 306 a selected serving device from the serving device set 136. This may be accomplished as described in connection with FIG. 1. For example, each of the serving devices 126 may measure a signal quality from each of the wireless devices 102 based on the beacons 138. The signal quality measurements may be sent to (e.g., shared with) one or more serving devices 126. One or more of the serving devices 126 may compare the signal quality measurements to determine a wireless device and serving device pair with the highest signal quality measurement. It should be noted that, in some cases, one or more serving devices 126 may be unable to receive and/or measure beacons from one or more wireless devices 102. In these cases, the serving device 126 may report the absence of a signal quality measure and/or may not send a report corresponding to those wireless devices 102.

The selected serving device 126 may send 308 an indication of the selected wireless device to the selected wireless device 102. This may be accomplished as described in connection with FIG. 1. The selected wireless device 102 may receive the indication of the selected wireless device. The selected wireless device 102 may determine one or more roles based on the indication. For example, the selected wireless device 102 may determine that it is the designated primary wireless device and/or that one or more other wireless devices 102 are designated non-primary wireless devices.

The selected serving device 126 may establish a connection with the selected wireless device. For example, a new connection may be established between the designated primary serving device and the designated primary wireless device. The previously established connection may be discontinued. In some approaches, for example, the designated primary serving device may send a connection established indicator to one or more other serving devices 126 (e.g., designated non-primary or secondary serving devices). Any serving device 126 having a previously established connection may discontinue the connection in response to the connection established indicator.

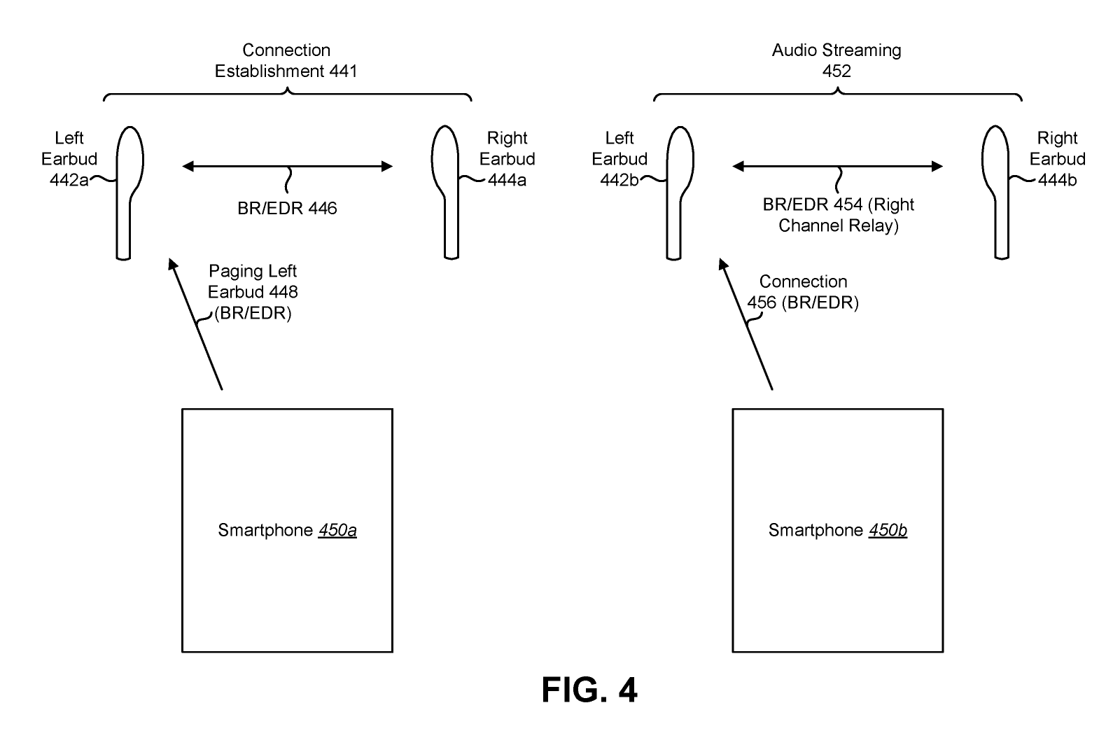

FIG. 4 is a block diagram illustrating one example of a scenario for streaming audio. In particular, the scenario illustrates a set of wireless earbuds that may be viewed as a single device by a smartphone 450a-b (or by another device, such as a personal computer (PC)). The scenario illustrates connection establishment 441 and audio streaming 452.

During connection establishment, the smartphone 450a may page one of the earbuds (e.g., the left earbud 442a). For example, the smartphone 450a may send paging 448 to the left earbud 442a and connect to the left earbud 442a over BR/EDR. The left earbud 442a may be connected to (e.g., in wireless communication with) the right earbud 444a using BR/EDR 446. It should be noted that BR/EDR 446 may not be Bluetooth Low Energy.

During audio streaming 452, the smartphone 450b provides data flow (e.g., audio) to the connected primary earbud (e.g., the left earbud 442b). The data flow may be provided via the connection 456 over BR/EDR. All of part of the data may be relayed by the left earbud 442b to the secondary right earbud 444b via a bud-to-bud wireless connection. For example, the right channel may be relayed over BR/EDR 454. The secondary right earbud 444b may extract data directly from the flow to the primary left earbud 442b.

In this scenario, the bud-to-bud wireless connection is entirely transparent to the smartphone. This may not require an update of a mainstream operating system to interoperate with a wireless earbud set.

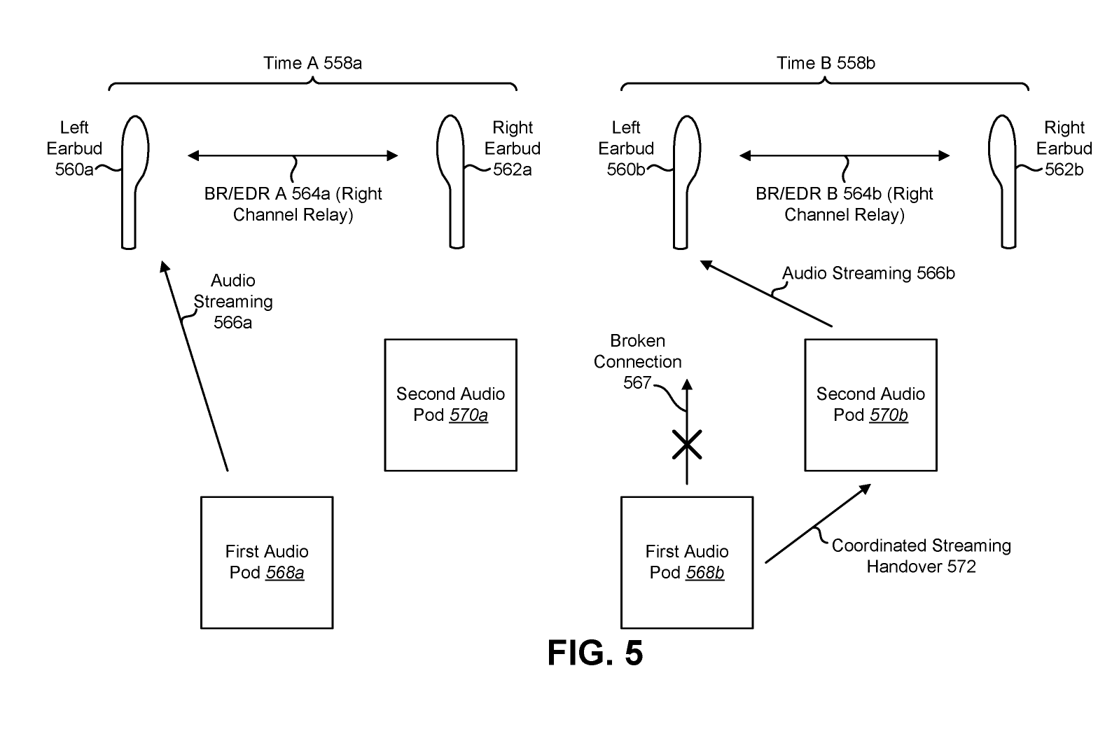

FIG. 5 is a block diagram illustrating a roaming scenario. As an earbud set (e.g., user) moves in the roaming scenario, the earbud set may be served by different service providers. Wireless connection to a single streaming device may be affected by range and propagation limitations. To address this issue, a network of service providers (which may be referred to as “audio pods” in connection with FIG. 5), may be distributed inside a building.

Once the presence of the earbud set (e.g., the left earbud 560a and the right earbud 562a) is detected (through detection of beaconing, for example), the pod network (e.g., first audio pod 568a and second audio pod 570a) may collaboratively establish which of the audio pods is the better suited to connect to the earbud set and become the serving audio pod. The serving audio pod may stream audio. At time A 558a, for example, the first audio pod 568a may perform audio streaming 566a to the left earbud 560a. The left earbud 560a may relay the right channel to the right earbud 562a over BR/EDR A 564a (e.g., a BR/EDR connection). As illustrated in FIG. 5, audio streaming 566a may be performed from one of many streaming devices.

As the earbuds (e.g., user, wearer, etc.) move and/or roam from room to room, propagation of signals between the earbud set and the serving pod is affected. A service handover may be orchestrated by the audio pod network. As described herein, handing over connectivity from one audio pod to another may include making and breaking of wireless connections between the two audio pods and the earbud set.

As illustrated in FIG. 5, the left earbud 560b and the right earbud 562b may have been handed over to the second audio pod 570b at time B 558b. For example, the first audio pod 568b may perform a coordinated streaming handover 572 with the second audio pod 570b. The audio streaming may be handed over before the original connection breaks down. In this scenario, the original connection with the first audio pod 568b is broken 567, and audio streaming 566b continues from the second audio pod 570b to the left earbud 560b. The left earbud 560b may continue to relay right channel audio to the right earbud 562b over BR/EDR B 564b. If the handover target is the left earbud 560b only (e.g., a static primary earbud), connection quality between the left earbud 560b and either audio pod 568b, 570b may not be optimal. For example, a user's body may be interposed between the audio pods 568b, 570b and the left earbud 560b, while the right earbud 562b position may offer a better (e.g., unobstructed) channel.

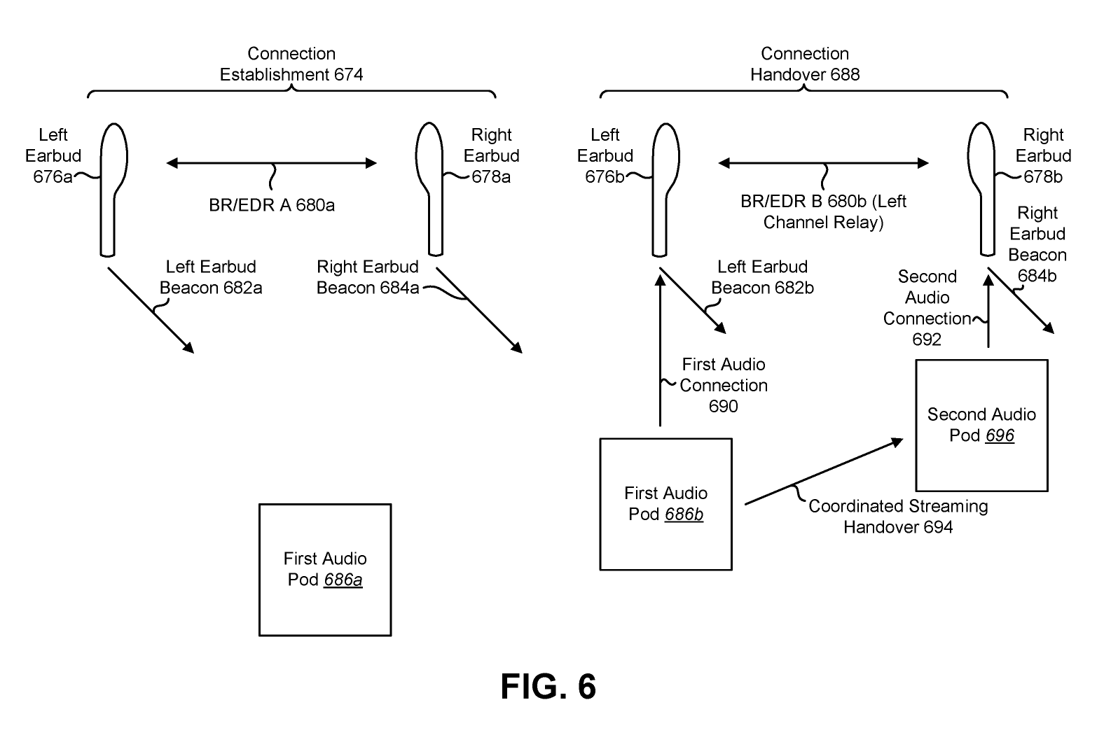

FIG. 6 is a block diagram illustrating a handover scenario. In this scenario, the connectivity target (e.g., the earbud set) may be viewed as a pair of distinct devices that may have very different signal propagation characteristics. Instead of encapsulating the wireless device set behind a static primary wireless device, some configurations of the systems and methods disclosed herein may explicitly take advantage of spatial separation and radio resource duplication of a set of wireless devices.

During connection establishment 674, both earbuds 676a, 678a may be targets for initial connection. Both the left earbud 676a and the right earbud 678a may beacon. For example, the left earbud 676a may send a left earbud beacon 682a and the right earbud 678a may send a right earbud beacon 684a. As illustrated in FIG. 6, the left earbud 676a may be connected to the right earbud 678a over BR/EDR A 680a (e.g., a BR/EDR connection). In some approaches, both earbuds 676a, 678a may beacon over Bluetooth Low Energy (BLE). The left earbud beacon 682a may indicate a left earbud address (e.g., BD_ADDR Left) and the right earbud beacon 684a may indicate a right earbud address (e.g., BD_ADDR Right). The pod network (e.g., the service provider, first audio pod 686a, etc.) may select which pod may attempt to connect and/or which earbud (e.g., left earbud 676a or right earbud 678a) to connect to. For example, the first audio pod 686a may select a “best” earbud (e.g., an earbud with a strongest beacon, beacon with highest signal quality, etc.). In some configurations, the first audio pod 686b may establish a first audio connection 690 (over BR/EDR, for example), which may be handed over to a second audio pod 696.

During connection handover 688, both earbuds 676b, 678b may cooperate in the management of the handover. For example, when connection quality (e.g., quality of the first audio connection 690 with the first audio pod 686b) starts deteriorating, both earbuds 676b, 678b may become detectable again (e.g., begin beaconing). For instance, the left earbud 676a may send a left earbud beacon 682b and the right earbud 678b may send a right earbud beacon 684b. In some approaches, both earbuds 676b, 678b may beacon over BLE. In one example, the right earbud beacon 684b may be the strongest beacon (of the left earbud beacon 682a and the right earbud beacon 684b).

In attempting to establish a new connection, a serving device (e.g., second audio pod 696) may give preference to a non-primary wireless device (e.g., the right earbud 678b). This is because the non-primary wireless device (e.g., the right earbud 678b) may be less busy in terms of signaling, and may have greater charge (e.g., less drain) on a battery.

During connection handover 688, the first audio pod 686b may perform a coordinated streaming handover 694 with the second audio pod 696. A second audio connection 692 may be established. In some configurations, the second audio pod 696 may connect to the right earbud 678b over BR/EDR. To cope with sudden drops, once the second audio connection 692 to the right earbud 678b is established, a duplicate of the stream of data may be exchanged over the new connection. For example, the second audio connection 692 may provide a stream of data that is the same as (e.g., a duplicate of) that provided by the first audio connection 690. The right earbud 678b may provide a left channel relay (over BR/EDR B 680b, for example).

When handover is completed, the initial connection (e.g., the first audio connection 690) is dropped and the formerly non-primary wireless device (e.g., the right earbud 678b) becomes the new primary wireless device.

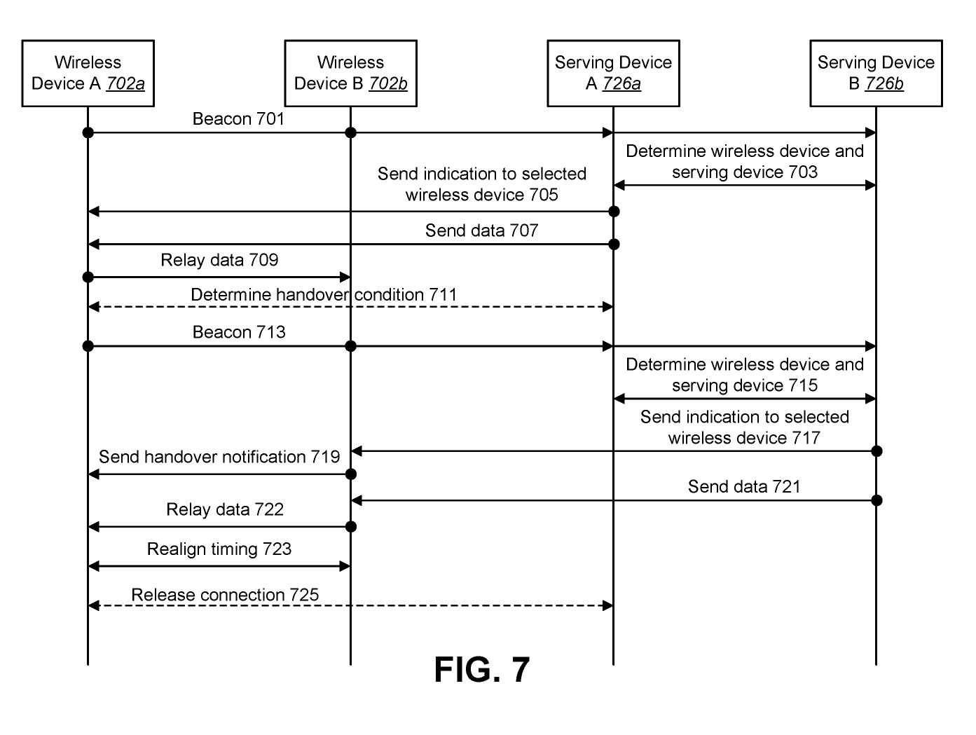

FIG. 7 is a thread diagram illustrating an example of wireless device set handover in accordance with some configurations of the systems and methods disclosed herein. In particular, FIG. 7 illustrates wireless device A 702a, wireless device B 702b, serving device A 726a, and serving device B 726b.

When attempting to establish an initial connection, wireless device A 702a and wireless device B 702b may beacon 701. For example, both wireless device A 702a and wireless device B 702b may send beacon signals to serving device A 726a and to serving device B 726b.

Serving device A 726a and serving device B 726b may cooperatively determine 703 a selected wireless device and a selected serving device. For example, signal quality measurements from both wireless devices 702a-b to both serving devices 726a-b (e.g., four signal quality measurements) may be sent, shared, and/or compared between the serving devices 726a-b. In the example given in FIG. 7, wireless device A 702a and serving device A 726a are selected for the initial connection. Accordingly, serving device A 726a may send 705 an indication to the selected wireless device. In some configurations, wireless device A 702a may notify wireless device B 702b that wireless device A 702a is the primary wireless device and/or that wireless device B 702b is a non-primary wireless device.

Serving device A 726a may send 707 data to wireless device A 702a (over the established connection, for example). Wireless device A 702a may relay 709 data to wireless device B 702b. For example, wireless device A 702a may relay all or part of the data received from serving device A 726a.

Serving device A 726a and/or wireless device A 702a may determine 711 a handover condition. For example, serving device A 726a may detect deterioration in the connection signal quality (e.g., a signal quality measurement may fall below a threshold). Additionally, or alternatively, wireless device A 702a may detect a connection loss with serving device A 726a.

In response to the handover condition determination 711, wireless device A 702a and wireless device B 702b may beacon 713. For example, both wireless device A 702a and wireless device B 702b may send beacon signals to serving device A 726a and to serving device B 726b.

Serving device A 726a and serving device B 726b may cooperatively determine 715 a selected wireless device and a selected serving device. For example, signal quality measurements from both wireless devices 702a-b to both serving devices 726a-b (e.g., four signal quality measurements) may be sent, shared, and/or compared between the serving devices 726a-b. In the example given in FIG. 7, wireless device B 702b and serving device B 726b are selected for the subsequent connection. Accordingly, serving device B 726b may send 717 an indication to the selected wireless device. In some configurations, wireless device B 702b may send 719 a handover notification and/or role indication to wireless device A 702a, notifying wireless device A 702a that wireless device B 702b in the designated primary wireless device and/or that wireless device A 702a is a designated non-primary wireless device.

Serving device B 726b may send 721 data to wireless device B 702b (over the established connection, for example). Wireless device B 702b may relay 722 data to wireless device A 702a. For example, wireless device B 702b may relay all or part of the data received from serving device B 726b.

It should be noted that serving device A 726a may continue to send 707 and/or wireless device A 702a may continue to relay 709 data until the subsequent connection has been established. In some configurations, wireless device A 702a and wireless device B 702b may realign 723 timing. In some approaches, timing may be realigned through the use of a time protocol when two devices will communicate with each other, such as a protocol between two devices in order to achieve music playing synchronization. For example, timestamps in audio packets may be utilized to realign 723 the timing. In some approaches, all data frames maybe timestamped, so that duplicate frames (i.e., the same frame received from two different pods or from a pod and relayed by the other wireless device) can be detected and/or aligned. In some configurations, once the subsequent connection has been established and/or the timing realigned, wireless device A 702a and/or serving device A 726a may release 725 the connection.

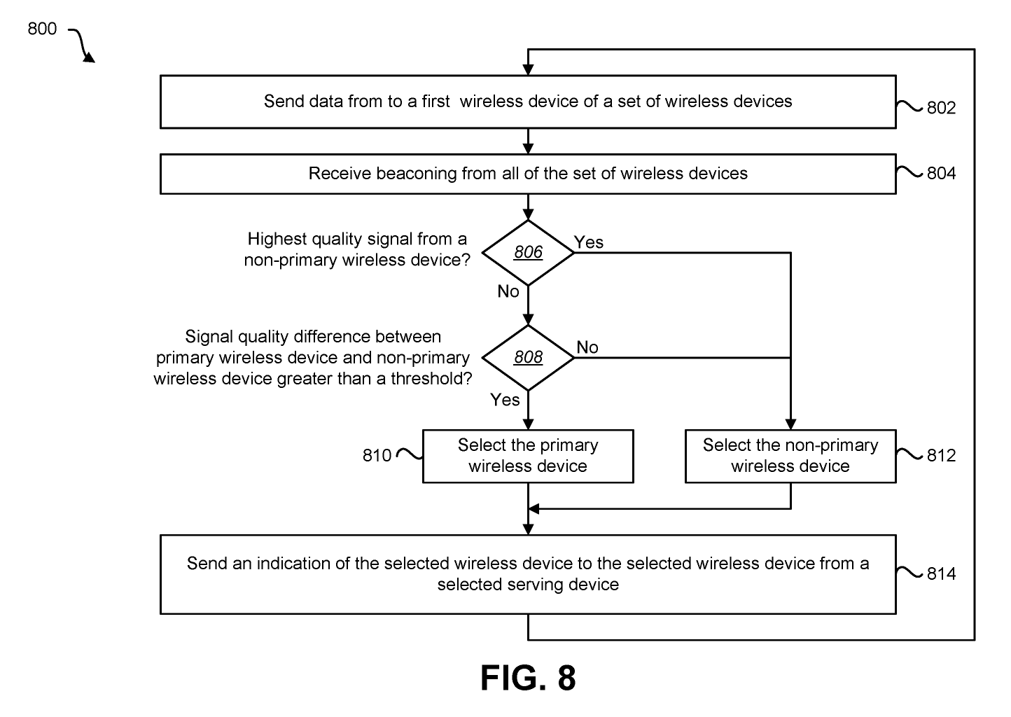

FIG. 8 is a flow diagram illustrating a more specific method 800 for handover of a set of wireless devices within a set of serving devices. The method 800 may be performed by one or more of the serving devices 126 (e.g., the serving device set 136) described in connection with FIG. 1. A serving device 136 in the serving device set 136 (e.g., a primary serving device 136) may send 802 data to a first wireless device 102 that is a primary wireless device. This may be accomplished as described in connection with one or more of FIGS. 1, 3, and 6-7. In some configurations, one or more serving devices 126 (e.g., the primary serving device) may determine a handover condition and/or send an indication of handover procedure initiation and/or of connection deterioration.

The serving device set 136 may receive 804 beaconing from all of the wireless device set 110. This may be accomplished as described in connection with one or more of FIGS. 1, 3, and 6-7. In some configurations, the beaconing (e.g., each beacon signal) may indicate (e.g., identify) the corresponding wireless device 102. For example, each beacon signal may include an address specifying the wireless device 102. Each of the serving devices 126 may determine signal quality measurements (e.g., RSSI, signal amplitude, packet loss ratio, SNR, etc.) from the beaconing corresponding to each wireless device 102.

The serving device set 136 may cooperatively determine 806 whether a highest quality signal is from a non-primary (e.g., secondary) wireless device. This may be accomplished as described in connection with one or more of FIGS. 1, 3, and 6-7. For example, one or more serving devices 126 may send, share, and/or compare signal quality measurements to determine which signal quality measurement is the highest. One or more of the serving devices 126 may determine whether the highest quality signal (e.g., beacon) is from a non-primary wireless device. For example, one or more of the serving devices 126 may determine whether the highest quality signal originated from the currently connected wireless device 102 (e.g., the primary wireless device). For instance, one or more of the serving devices 126 may compare an address of the highest quality signal to an address of the currently connected wireless device 102. If the addresses match, the highest quality signal is not from a non-primary wireless device. Alternatively, if the addresses do not match, the highest quality signal is from the non-primary wireless device. If the highest quality signal is from a non-primary wireless device, the one or more serving devices 126 may select 812 the non-primary wireless device.

If the highest quality signal is not from a non-primary wireless device (e.g., is from the primary wireless device), the one or more serving devices 126 may determine 808 whether a signal quality difference between the primary wireless device and the non-primary wireless device is greater than a threshold. For example, one or more of the serving devices 126 may determine a difference between the signal quality from the primary wireless device and the next highest signal quality from a non-primary wireless device. If the signal quality difference is not greater than the threshold, the one or more serving devices 126 may select 812 the non-primary wireless device. If the signal quality difference is greater than the threshold, the one or more serving devices 126 may select 810 the primary wireless device.

Thresholding the signal quality difference is one way to favor selecting the non-primary wireless device over the primary wireless device in handover in accordance with some configurations of the systems and methods disclosed herein. Other configurations of the systems and methods disclosed herein may include adjusting the signal quality measurements. For example, a penalty (e.g., decrease) may be applied to the signal quality measurements corresponding to the primary wireless device and/or an aid (e.g., increase) may be applied to the signal quality measurements corresponding to the non-primary wireless device(s). Then, the device corresponding to the highest resulting signal quality measure may be selected.

In yet other approaches that may be implemented in accordance with the systems and methods disclosed herein, one or more other factors may be taken into account. For example, each of the wireless devices may send an indication of battery charge in and/or with the beacon signal. A non-primary wireless device may only be favored if the non-primary wireless device battery charge is higher that the primary wireless device battery charge. Additionally, or alternatively, a primary wireless device may only be disfavored if the non-primary wireless device battery charge is higher that the primary wireless device battery charge.

The selected serving device 126 may send 814 an indication of the selected wireless device to the selected wireless device 102. This may be accomplished as described in connection with one or more of FIGS. 1,3 and 6-7. The selected serving device 126 may establish a connection with the selected wireless device. This may be accomplished as described in connection with one or more of FIGS. 1,3 and 6-7.

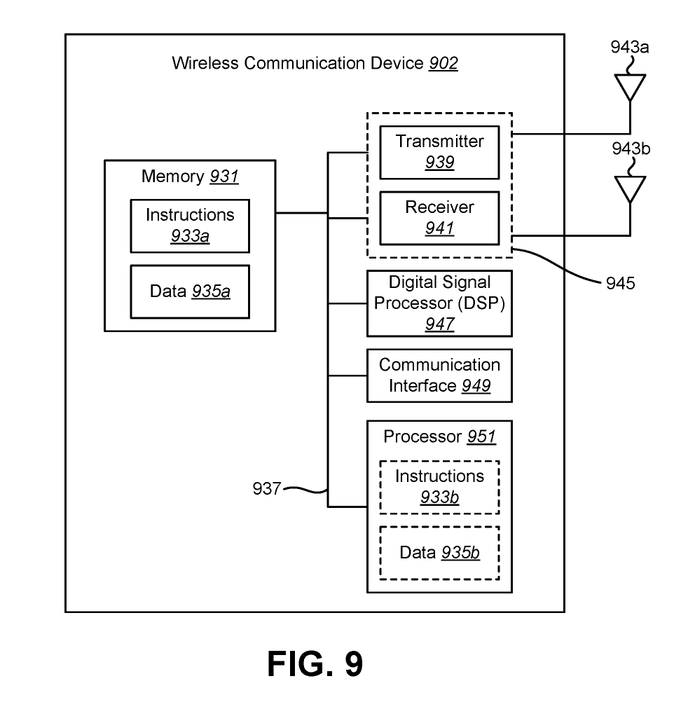

FIG. 9 illustrates certain components that may be included within a wireless communication device 902. The wireless communication device 902 may be a wireless device, a serving device, a smartphone, a wireless speaker, a wireless earbud, a wireless headset, a laptop computer, a desktop computer, etc. In some configurations, the wireless communication device 902 may be implemented in accordance with the wireless device 102 or serving device 126 described in connection with FIG. 1.

The wireless communication device 902 includes a processor 951. The processor 951 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 951 may be referred to as a central processing unit (CPU). Although just a single processor 951 is shown in the wireless communication device 902 of FIG. 9, in an alternative configuration, a combination of processors (e.g., an ARM and DSP) could be used.

The wireless communication device 902 also includes memory 931 in electronic communication with the processor (e.g., the processor 951 can read information from and/or write information to the memory 931). The memory 931 may be any electronic component capable of storing electronic information. The memory 931 may be configured as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 935a and instructions 933a may be stored in the memory 931. The instructions may include one or more programs, routines, sub-routines, functions, procedures, code, etc. The instructions may include a single computer-readable statement or many computer-readable statements. The instructions 933a may be executable by the processor 951 to implement one or more of the methods disclosed herein. Executing the instructions 933a may involve the use of the data 935a that is stored in the memory 931. When the processor 951 executes the instructions 933, various portions of the instructions 933b may be loaded onto the processor 951, and various pieces of data 935b may be loaded onto the processor 951.

The wireless communication device 902 may also include a transmitter 939 and a receiver 941 to allow transmission and reception of signals to and from the wireless communication device 902 via one or more antennas 943a-b. The transmitter 939 and receiver 941 may be collectively referred to as a transceiver 945. The wireless communication device 902 may also include (not shown) multiplier transmitters, multiplier receivers, and/or multiplier transceivers.

The wireless communication device 902 may include a digital signal processor (DSP) 947. The wireless communication device 902 may also include a communications interface 949. The communications interface 949 may provide one or more interfaces for input and/or output. In some configurations, the communication interface 949 may allow a user to interact with the wireless communication device 902. Additionally, or alternatively, the communication interface 949 may provide one or more interfaces for wireline communication in some configurations.

The various components of the wireless communication device 902 may be coupled together by one or more buses, which may include a power bus, a control signal bus, a status signal bus, a data bus, etc. For the sake of clarity, the various buses are illustrated in FIG. 9 as a bus system 937.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims. It should be noted that one or more steps, actions, or elements of one configuration may be combined with and/or substituted for one or more steps, actions, or elements of another configuration. Additionally or alternatively, one or more steps, actions, or elements may be omitted from some configurations.

Further, it should be appreciated that modules and/or other appropriate means for performing the methods and techniques described herein, such as illustrated by FIG. 2, FIG. 3, and FIG. 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B, and C” or the phrase “one or more of A, B, or C” should be interpreted to mean any of: only A, only B, only C, A and B (but not C), B and C (but not A), A and C (but not B), or all of A, B, and C.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for handover of a set of wireless devices, the method comprising:
receiving, at a first wireless device of the set of wireless devices, data from a first serving device of a set of serving devices, wherein the first wireless device has a primary wireless device role and a second wireless device has a non-primary wireless device role;
determining, at the first wireless device, a handover condition for the set of wireless devices, wherein the set of wireless devices is handed over as a set to a second serving device;
becoming detectable, by the first wireless device, wherein each of the wireless devices in the set of wireless devices is configured to become detectable in response to the handover condition; and
receiving, by the first wireless device, an indication of a selected wireless device of the set of wireless devices.

2. The method of claim 1, wherein the selected wireless device is a designated primary wireless device that takes the primary wireless device role upon handover.

3. The method of claim 2, wherein the selected wireless device is the second wireless device that takes the primary wireless device role upon handover, and wherein the first wireless device becomes a designated non-primary wireless device that takes the non-primary wireless device role upon handover.

4. The method of claim 3, wherein receiving the indication of the selected wireless device comprises receiving, by the first wireless device from the second wireless device, an indicator that the second wireless device is the designated primary wireless device.

5. The method of claim 3, further comprising receiving second data by the first wireless device, wherein the second data is relayed by the second wireless device to the first wireless device from the second serving device of the set of serving devices.

6. The method of claim 1, wherein determining the handover condition comprises determining that the primary wireless device has lost connection with the set of serving devices.

7. The method of claim 1, wherein determining the handover condition comprises receiving an indication from the first serving device that a measured signal quality is below a threshold.

8. The method of claim 1, wherein the set of wireless devices is a set of wireless audio output devices.

9. The method of claim 1, wherein the set of wireless devices is a set of Bluetooth devices and the set of serving devices is a set of Bluetooth serving devices.

10. The method of claim 1, wherein becoming detectable comprises beaconing.

11. The method of claim 1, wherein the set of wireless devices comprises two or more non-primary wireless devices that have the non-primary device role.

12. The method of claim 1, wherein the set of serving devices form a connected graph topology.

13. A first wireless device for handover of a set of wireless devices, comprising:
a memory;
a processor coupled to the memory, wherein the processor is configured to:
receive, at the first wireless device, data from a first serving device of a set of serving devices, wherein the first wireless device has a primary wireless device role and a second wireless device has a non-primary wireless device role;
determine a handover condition for the set of wireless devices, wherein the set of wireless devices is handed over as a set to a second serving device;
become detectable, wherein each of the wireless devices in the set of wireless devices is configured to become detectable in response to the handover condition; and
receive an indication of a selected wireless device of the set of wireless devices.

14. The first wireless device of claim 13, wherein the selected wireless device is a designated primary wireless device configured to take the primary wireless device role upon handover.

15. The first wireless device of claim 14, wherein the selected wireless device is the second wireless device, and wherein the processor is configured to take the non-primary wireless device role upon handover.

16. The first wireless device of claim 15, wherein the processor is configured to receive the indication of the selected wireless device by receiving, from the second wireless device, an indicator that the second wireless device is the designated primary wireless device.

17. The first wireless device of claim 13, wherein the processor is configured to determine the handover condition by determining that the primary wireless device has lost connection with the set of serving devices.

18. The first wireless device of claim 13, wherein the processor is configured to determine the handover condition by receiving an indication from the first serving device that a measured signal quality is below a threshold.

19. A non-transitory tangible computer-readable medium for handover of a set of wireless devices, the computer-readable medium comprising:
code for causing a first wireless device to receive, at the first wireless device of the set of wireless devices, data from a first serving device of a set of serving devices, wherein the first wireless device has a primary wireless device role and a second wireless device has a non-primary wireless device role;
code for causing the first wireless device to determine a handover condition for the set of wireless devices, wherein the set of wireless devices is handed over as a set to a second serving device;
code for causing the first wireless device to become detectable, wherein each of the wireless devices in the set of wireless devices is configured to become detectable in response to the handover condition; and
code for causing the first wireless device to receive an indication of a selected wireless device of the set of wireless devices.

20. The computer-readable medium of claim 19, wherein the selected wireless device is a designated primary wireless device that takes the primary wireless device role upon handover.

21. The computer-readable medium of claim 20, wherein the selected wireless device is the second wireless device, and wherein the computer-readable medium comprises code for causing the first wireless device to take the non-primary wireless device role upon handover.

22. The computer-readable medium of claim 21, wherein the code for causing the first wireless device to receive the indication of the selected wireless device comprises code for causing the first wireless device to receive, from the second wireless device, an indicator that the second wireless device is the designated primary wireless device.

23. The computer-readable medium of claim 19, wherein the code for causing the first wireless device to determine the handover condition comprises code for causing the first wireless device to determine that the primary wireless device has lost connection with the set of serving devices.

24. The computer-readable medium of claim 19, wherein the code for causing the first wireless device to determine the handover condition comprises code for causing the first wireless device to receive an indication from the first serving device that a measured signal quality is below a threshold.

25. A method for handover by a set of serving devices, the method comprising:
sending first data from one of the set of serving devices to a first wireless device that has a primary wireless device role;
receiving, at one or more of the set of serving devices, a signal from at least one of a set of wireless devices, wherein each of the set of wireless devices is configured to become detectable in response to a handover condition;
cooperatively determining, by all of the set of serving devices in response to the received signal, a selected wireless device of the set of wireless devices and a selected serving device of the set of serving devices; and
sending an indication of the selected wireless device from the selected serving device to the selected wireless device.

26. The method of claim 25, further comprising:
determining the handover condition by determining that a measured signal quality for the first wireless device is below a threshold; and
sending, from the one of the set of serving devices to the first wireless device, an indication that the measured signal quality is below the threshold.

27. The method of claim 25, wherein cooperatively determining the selected wireless device and the selected serving device comprises determining a signal quality measurement for two or more pairs, wherein each pair includes a wireless device and a serving device.

28. The method of claim 27, wherein cooperatively determining the selected wireless device and the selected serving device further comprises determining a wireless device and serving device pair based on the signal quality measurement and a wireless device role for each of the set of wireless devices, wherein the determination favors a second wireless device that has a non-primary wireless device role over the first wireless device that has the primary wireless device role.

29. The method of claim 28 wherein the selected wireless device takes the primary wireless device role upon handover.

30. The method of claim 25, wherein the set of serving devices form a connected graph topology.
